(19) United States
(12) Patent Application Publication
(10) Pub. No.: US 2014/0332340 A1
(43) Pub. Date: Nov. 13, 2014

(54) BANKNOTE PROCESSING DEVICE

(71) Applicant: Oki Electric Industry Co., Ltd., Tokyo (JP)

(72) Inventors: Akira Adachi, Tokyo (JP); Akihiro Sasaki, Tokyo (JP)

(73) Assignee: OKI ELECTRIC INDUSTRY CO., LTD., Tokyo (JP)

(21) Appl. No.: 14/362,729

(22) PCT Filed: Nov. 1, 2012
(86) PCT No.: PCT/JP2012/078379

§ 371 Date: Jun. 4, 2014

(30) Foreign Application Priority Data
Dec. 5, 2011 (JP) 2011-265560

(51) Int. Cl. G07D 11/00; B65H 43/04; G07F 19/00; B65H 29/60

(52) U.S. Cl. CPC G07D 11/0084; B65H 29/60; B65H 43/04; G07F 19/203; B65H 2701/1912
USPC 194/206

(57) ABSTRACT

A banknote processing device is provided that is capable of securing a reject route that does not overlap with a route for conveying banknotes from a banknote storage section to a banknote identification section. The banknote processing device includes: a dispensing port that dispenses banknotes; a banknote identification section that identifies whether or not banknotes are normal; and a storage-only storage section that stores banknotes that the banknote identification section has identified as abnormal. Out of a first route on the dispensing port side between the banknote identification section and the storage-only storage section and a second route on the opposite side to the first route, one, or two or more, banknote storage sections capable of storing and feeding out banknotes are provided only on the second route side.

### TECHNICAL FIELD

The present invention relates to a banknote processing device.

### BACKGROUND ART

Recently, cash processing devices, typified by service counter cash processing machines installed at service counters in branches of financial institutions, are being employed, for example, in pay-in and pay-out transactions with banknotes and coins, as well as for check counting. A member of staff is able to perform, for example, pay-in and pay-out transactions by performing various operations on an operation section of the cash processing device, or on a reception terminal (data processing device) connected to the cash processing device.

Such a cash processing device installed between two tellers (operators) enables banknotes and coins to be paid in and paid out. Patent Document 1 (Japanese Patent Application Laid-Open (JP-A) No. 2001-93022) discloses a circulation type currency processor that has a structure in which, when the circulation type currency processor is employed installed between two tellers, the position of, for example, a banknote pay-in port can be changed, to enable easy operation by either teller.

Moreover, as disclosed in Patent Document 1 (JP-A No. 2001-93022), banknote processing devices that handle banknotes are provided with plural banknote storage sections in which banknotes are stacked, enabling banknotes that are paid in and paid out to be stacked according to denomination. Banknote processing devices are moreover known which, in addition to plural banknote storage sections to stack banknotes that are paid in and paid out, are also provided with a banknote storage box employed to replenish the banknotes in the plural banknote storage sections and to recover banknotes from the plural banknote storage sections, and with a banknote storage section with reject box that includes a reject box to stack reject banknotes. The banknote storage box includes similar functions to the banknote storage sections, namely a banknote stacking function and a banknote separating function.

### DISCLOSURE OF INVENTION

### Technical Problem

However, hitherto replenishment and recovery banknote storage boxes have not been employed in, for example, pay-out transactions, despite having similar functions to the banknote storage sections used in pay-in and pay-out.

Normally, when a banknote processing device performs a pay-out transaction, banknotes are fed out from the banknote storage sections, and the fed out banknotes are classified by a banknote identification section. Banknotes (reject banknotes) that the banknote identification section classifies as abnormal are stacked in the reject box. In a hypothetical case in which banknotes are paid out from the banknote storage box in such a pay-out transaction, there is an issue that a portion of the conveyance route of a banknote from the banknote storage box to the banknote identification section, overlaps with a conveyance route (reject route) of banknotes from the banknote identification section to the reject box.

Since the reject route from the banknote storage box cannot be secured, it has not hitherto been possible to employ the banknote storage box in a pay-out transaction.

In consideration of the above circumstances, an object of the present invention is to provide a new and improved banknote processing device capable of securing a reject route that does not overlap with a banknote conveyance route from a banknote storage section to a banknote identification section.

### Solution to Problem

In order to address the above issues, an aspect of the present invention provides a banknote processing device including: a dispensing port that dispenses banknotes; a banknote identification section that identifies whether or not banknotes are normal; and a storage-only storage section that stores banknotes that the banknote identification section has identified as abnormal, wherein out of a first route on the dispensing port side between the banknote identification section and the storage-only storage section and a second route on the opposite side to the first route, one, or two or more, banknote storage sections capable of storing and feeding out banknotes are provided only on the second route side.

The banknote processing device may be configured to further include a control section that in a pay-out transaction controls conveyance such that banknotes fed out from the banknote storage section are conveyed to the banknote identification section via the second route.

The control section may be configured to control conveyance such that any of the banknotes rejected by the banknote identification section are conveyed to the storage-only storage section via the first route.

The banknote processing device may be configured to further include a temporary holding section that is provided on the first route, and that temporarily stores the banknotes, wherein the control section controls conveyance such that any of the banknotes rejected by the banknote identification section are conveyed to the temporary holding section via the first route, and after the pay-out transaction has been completed, the banknotes stored in the temporary holding section are conveyed to the storage-only storage section via the first route.

The banknote processing device may be configured to further include a control section that controls conveyance during dispensing port recovery such that banknotes fed out from the banknote storage section are conveyed to the banknote identification section via the second route.

The banknote processing device may be configured to further include a temporary holding section that is provided on the first route to temporarily store banknotes, wherein the control section controls conveyance such that any banknotes rejected by the banknote identification section are conveyed to the temporary holding section via the first route, and after every banknote has been fed out from the banknote storage section, the banknotes stored in the temporary holding section are conveyed to the dispensing port.

The control section may be configured to control conveyance such that banknotes identified by the banknote identification section as normal are conveyed to the dispensing port.

### Advantageous Effects of Invention

As described above, according to the present invention it is possible to secure a reject route that does not overlap with a banknote conveyance route from a banknote storage section to a banknote identification section.

### BRIEF DESCRIPTION OF DRAWINGS

FIG. 1 is an explanatory diagram illustrating a configuration of a banknote processing system according to an exemplary embodiment of the present invention.

FIG. 2 is a drawing to explain overlap in a reject route.

FIG. 3 is a drawing illustrating an internal structure of a banknote processing device according to an exemplary embodiment of the present invention.

FIG. 4 is a block diagram illustrating a functional configuration of a banknote processing device according to an exemplary embodiment of the present invention.

FIG. 5 is a drawing illustrating a conveyance route of banknotes that have been given a classification result of normal by a banknote identification section in a pay-in transaction.

FIG. 6 is a drawing illustrating conveyance routes in stacking processing to stack normal banknotes that are stacked in a temporary holding section in banknote cassettes of corresponding denominations in a pay-in transaction.

FIG. 7 is a drawing illustrating conveyance routes of banknotes fed out from a pay-in port and stacked directly in banknote cassettes in direct pay-in processing.

FIG. 8 is a flow chart illustrating banknote conveyance control in a pay-out transaction according to a first exemplary embodiment of the present invention.

FIG. 9 is a drawing illustrating conveyance routes of normal banknotes under banknote conveyance control in a pay-out transaction according to the first exemplary embodiment of the present invention.

FIG. 10 is a drawing illustrating conveyance routes of reject banknotes (reject route) under banknote conveyance control in a pay-out transaction according to the first exemplary embodiment of the present invention.

FIG. 11 is a drawing illustrating a conveyance route (reject route) of reject banknotes stacked in a temporary holding section to a storage-only cassette under banknote conveyance control in a pay-out transaction according to the first exemplary embodiment of the present invention.

FIG. 12 is a flow chart illustrating banknote conveyance control in a pay-out transaction according to a second exemplary embodiment of the present invention.

FIG. 13 is a drawing illustrating conveyance routes (reject route) of reject banknotes under banknote conveyance control in a pay-out transaction according to the second exemplary embodiment of the present invention.

FIG. 14 is a flow chart illustrating banknote conveyance control in pay-out port recovery according to the third exemplary embodiment of the present invention.

FIG. 15 is a drawing illustrating a conveyance route (reject route) to dispense reject banknotes stacked in a temporary holding section under banknote conveyance control in pay-out port recovery according to the third exemplary embodiment of the present invention.

### BEST MODE FOR CARRYING OUT THE INVENTION

Detailed explanation follows regarding a preferable exemplary embodiment of the present invention, with reference to the accompanying drawings. Note that in the present specification and in the drawings, configuration elements with effectively the same function and configuration as each other are allocated the same reference numerals, and redundant explanation thereof is omitted.

### 1. Banknote Processing System Outline

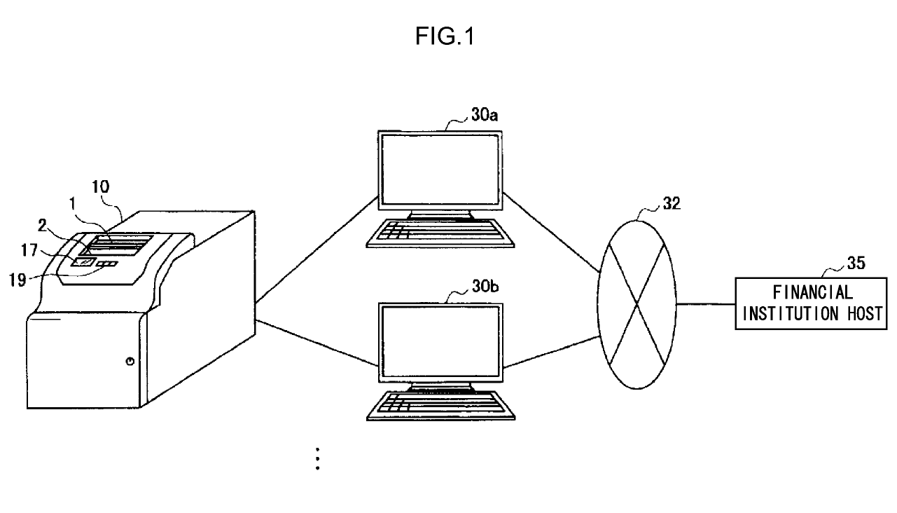

First, explanation is given regarding a banknote processing system according to an exemplary embodiment of the present invention, with reference to FIG. 1.

FIG. 1 is an explanatory diagram illustrating a configuration of a banknote processing system according to an exemplary embodiment of the present invention. As illustrated in FIG. 1, the banknote processing system includes a banknote processing device 10, reception terminals 30a, 30b that connect to the banknote processing device 10, a dedicated network 32, and a financial institution host 35. In the example illustrated in FIG. 1, plural reception terminals 30 are connected to the banknote processing device 10. However there is no limitation of the banknote processing system thereto, and a single reception terminal 30 may be connected to the banknote processing device 10. The respective reception terminals 30 are connected to the financial institution host 35 via the dedicated network 32.

The banknote processing device 10 is a staff-operated terminal that performs financial transactions, for example, under the operation of a member of staff at a service counter of a financial institution. The banknote processing device 10 is installed in a branch of a financial institution or the like.

As illustrated in FIG. 1, the banknote processing device 10 further includes a pay-in port 1 into which banknotes are inserted, a pay-out port 2 that dispenses banknotes, a display section 17, and an operation section 19. The display section 17 displays a menu screen and a processing result screen. The display section 17 is, for example, implemented by a Cathode Ray Tube (CRT) display device, a Liquid Crystal Display (LCD) device, or an Organic Light Emitting Diode (OLED) device. The operation section 19 detects operation by a member of staff. The operation section 19 is implemented by, for example, buttons, switches, or a touch panel. Note that FIG. 1 illustrates an operation function and a display function provided separately to one another, however the banknote processing device 10 of the present exemplary embodiment is not limited thereto, and the operation function and display function may be provided together. The banknote processing device 10 may also display a guidance screen that guides operation by the member of staff on a display section including an operation detection function.

The pay-in port 1 is an insertion port into which banknotes are inserted by the member of staff. The pay-in port 1 may be provided with a shutter (not illustrated in the drawings) that opens and closes an opening portion. The pay-in port 1 moreover includes a separating function for separating banknotes inserted in a bundle to be fed out, one note at a time.

The pay-out port 2 is a dispensing port that dispenses banknotes to be removed by the member of staff. The pay-out port 2 may be provided with a shutter (not illustrated in the drawings) that opens and closes an opening portion. The pay-out port 2 moreover includes a stacking function for stacking dispensed banknotes.

The reception terminals 30 are data processing devices that perform reception tasks. The reception terminals 30 have a wired or wireless connection to the banknote processing device 10, and transmit instructions to the banknote processing device 10 to perform a processing mode (such as a pay-in or pay-out transaction, pay-out port recovery, or check counting) selected by the member of staff. The banknote processing device 10 of the present exemplary embodiment may therefore be operated by using a data processing device connected to the banknote processing device 10, as well as by using the operation section 19 provided to the banknote processing device 10.

The dedicated network 32 is a network belonging to a financial institution that includes a branch, or plural branches, installed with a reception terminal 30. The dedicated network 32 is configured by, for example, an Internet Protocol-Virtual Private Network (IP-VPN). The financial institution host 35 is able to communicate with plural reception terminals 30 over the dedicated network 32.

The financial institution host 35 controls various transactions by communicating with the reception terminals 30, or with the banknote processing devices 10 through the reception terminals 30, over the dedicated network 32. For example, the financial institution host 35 performs customer verification and financial transactions (account transaction processing) such as pay-in or bank transfers instructed by the member of staff. The financial institution host 35 also manages customer information (account ledgers) including, for example, an account number, personal identification number, name, address, age, date of birth, telephone number, occupation, family members, income and balance amount.

An exemplary embodiment of the present invention relates to the banknote processing device 10 included in the banknote processing system described above, and in particular relates to securing a reject route in the banknote processing device 10 during pay-out transactions and pay-out port recovery.

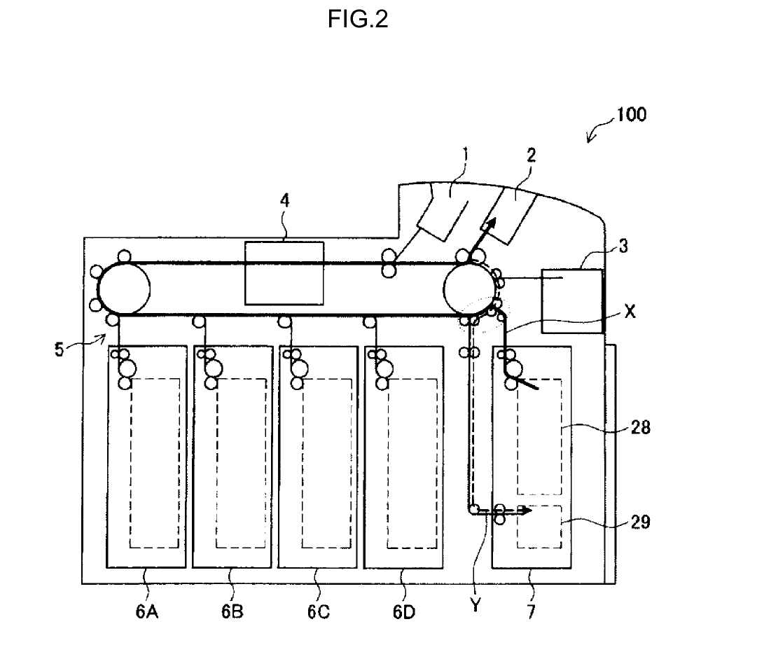

Explanation follows regarding two issues concerning the reject route in pay-out transactions and pay-out port recovery, with reference to FIG. 2. FIG. 2 is a drawing explaining reject route overlap. As illustrated in FIG. 2, a banknote processing device 100 includes a banknote cassette 7 with reject box (referred to below as the banknote cassette 7) that includes a banknote storage box 28, and a reject box 29 provided at a bottom portion. The banknote cassette 7 has a structure detachable from the banknote processing device 100, enabling banknotes to be recovered and replenished by individually exchanging the banknote cassette 7.

The banknote storage box 28 has a stacking function for stacking banknotes, and a separating function for feeding out banknotes, one note at a time. In counted cassette recovery, the banknote storage box 28 is capable of stacking banknotes spread between respective banknote cassettes 6A to 6D and recovering the banknotes. In counted cassette replenishment, the banknote storage box 28 is also capable of feeding out banknotes stacked inside the banknote storage box 28 and replenishing the banknote cassettes 6A to 6D with banknotes.

The reject box 29 includes only a stacking function for stacking banknotes. The reject box 29 is a banknote storage section for stacking banknotes (reject banknotes) classified as abnormal (reject determination) by a banknote identification section 4.

In a pay-out transaction, normally banknotes corresponding to a specified amount are separated from the banknote cassettes 6A to 6D, one note at a time, and the separated banknotes are conveyed to the banknote identification section 4. Banknotes given a classification result of normal by the banknote identification section 4 are stacked in the pay-out port 2. However, banknotes given a classification result of abnormal by the banknote identification section 4, namely banknotes that cannot be paid out to a customer, are stacked in the reject box 29.

In a hypothetical case in which banknotes are paid out from the banknote storage box 28 during such a pay-out transaction, banknotes given a classification result of normal by the banknote identification section 4 are stacked in the pay-out port 2 via a conveyance path X, illustrated by a solid line in FIG. 2. However, any banknotes given a classification result of abnormal by the banknote identification section 4 are stacked in the reject box 29 via a conveyance path Y (reject route) illustrated by a broken line in FIG. 2. However, since a portion of the conveyance path Y overlaps with the conveyance path X, the reject route cannot be secured, meaning the banknote storage box 28 cannot be employed in pay-out transactions.

Moreover, in a pay-out port recovery operation (dispensing port recovery operation) in which banknotes stacked inside the banknote cassettes 6A to 6D are stacked in the pay-out port 2 (dispensing port) and recovered by a member of staff, banknotes given a classification result of abnormal by the banknote identification section 4 are normally stacked in the reject box 29. In a hypothetical case in which pay-out port recovery is performed from the banknote storage box 28 in such a pay-out port recovery operation, the issue of being unable to secure the reject route arises, similarly to in a pay-out transaction.

The banknote processing device 10 of an exemplary embodiment of the present invention has been developed in consideration of the above circumstances. The banknote processing device 10 of an exemplary embodiment of the present invention includes stacking and separating functions, and enables a reject route to be secured when pay-out or pay-out port recovery is performed using banknote cassettes in which banknotes can be stored according to denomination. Explanation follows regarding configuration and basic operation of the banknote processing device 10 of an exemplary embodiment of the present invention, before proceeding to detailed explanation regarding securing a reject route in an exemplary embodiment of the present invention.

### 2. Banknote Processing Device 10 Configuration and Basic Operation

### 2-1. Internal Configuration

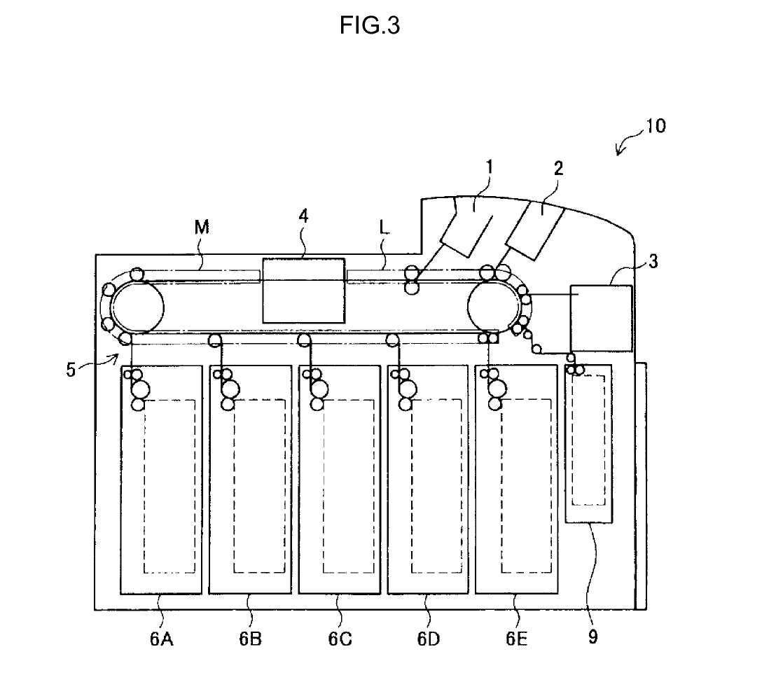

FIG. 3 illustrates an internal configuration of the banknote processing device 10. As illustrated in FIG. 3, the banknote processing device 10 includes the pay-in port 1, the pay-out port 2, a temporary holding section 3, the banknote identification section 4, a conveyance section 5, banknote cassettes 6A to 6E, and a storage-only cassette 9.

As described above, the pay-in port 1 has a separating function for feeding out inserted banknotes, one note at a time. As described above, the pay-out port 2 has a stacking function for stacking dispensed banknotes. Note that the pay-in port 1 and the pay-out port 2 may be movable, so as to be capable of inclining toward the conveyance path side or toward a side with an opening for collection by a member of staff.

The temporary holding section 3 has both a banknote separating and a banknote stacking function. In a pay-in transaction, for example, the temporary holding section 3 temporarily stacks banknotes that have been separated out from the pay-in port 1 and classified as normal by the banknote identification section 4. Banknotes stacked in the temporary holding section 3 are fed out on successful completion of a transaction, for example when the paid-in banknotes have been confirmed in the account, and are conveyed through the banknote identification section 4 to, for example, the banknote cassettes 6A to 6E. Note that the temporary holding section 3 may be a stacking type that sequentially stacks banknotes one on top of the other, or may be a drum type that stores banknotes by sequential wrapping.

The banknote identification section 4 classifies passing banknotes, one note at a time. Banknotes may travel in either direction, and the banknote identification section 4 is capable of classifying both banknotes being conveyed from the pay-in port 1, and banknotes being conveyed from the opposite direction. Specifically, the banknote identification section 4 classifies a conveyed banknote passing through the conveyance path according to denomination, authenticity, physical condition, and traveling state, conferring normal determination or reject determination on the passing banknote. Reject determination is made based on factors such as authenticity, physical condition (for example dirt, damage, non-standard shape), and traveling abnormality (for example skewed banknotes, overlapping travel). Reject banknotes may also include, for example, banknotes that are not used in pay-out, such as 2000 yen notes or 5000 yen notes, or foreign currency banknotes.

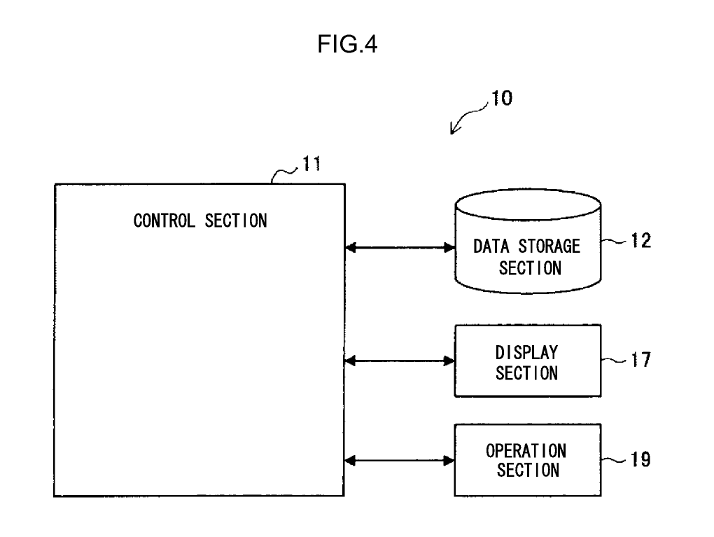

The conveyance section 5 includes respective conveyance paths that convey banknotes, respective conveyance rollers, and a drive mechanism for driving respective conveyance paths. The drive mechanism drives the conveyance paths by, for example, rotating a DC servomotor or a pulse motor. The conveyance section 5 is controlled by a control section (see the control section 11 in FIG. 4), described later, to convey a banknote to its conveyance destination.

The banknote cassettes 6A to 6E are banknote storage sections capable of storing banknotes according to denomination, and include both a banknote stacking function and separating function. The banknote cassettes 6A to 6E may include plural banknote cassettes for a single denomination. For example, the banknote cassettes 6A and 6C may be banknote cassettes for 10,000 yen notes, and the banknote cassettes 6B, 6D and 6E may be banknote cassettes for 1000 yen notes. The respective banknote cassettes 6A to 6E may be configured with a structure detachable from the banknote processing device 10, enabling individual exchange in order to load banknotes into the banknote cassettes 6A to 6E.

As illustrated in FIG. 3, out of a first route L on the pay-out port 2 side between the banknote identification section 4 and the storage-only cassette 9, and a second route M on the opposite side of the banknote identification section 4 to the first route L, the banknote cassettes 6A to 6E of the present exemplary embodiment are provided on the second route M side only. Note that in the example illustrated in FIG. 3, a downstream portion of the first route L is linked to an upstream portion of the second route M, configuring a loop shaped conveyance path including the first route L and the second route M, however the route of the present exemplary embodiment is not limited thereto. For example, the downstream portion of the first route L may be isolated from the upstream portion of the second route M.

The banknote cassette 6E may stack and recover banknotes that have been separated from the respective banknote cassettes 6A to 6D during counted cassette recovery. The banknote cassette 6E may also feed out banknotes stacked inside the banknote cassette 6E to replenish the banknotes in the banknote cassettes 6A to 6D during counted cassette replenishment.

The banknote storage boxes according to the present exemplary embodiment are not limited to cassettes detachable from the banknote processing device 10, and may be configured by stackers (banknote stackers A to E) that are not detachable from the banknote processing device 10.

The storage-only cassette 9 is a storage-only storage section including only a stacking function for stacking banknotes. The storage-only cassette 9 stacks any banknotes (reject banknotes) that the banknote identification section 4 has classified as abnormal (reject determination).

Detailed explanation has been given above regarding the internal structure of the banknote processing device 10 included in the banknote processing system according to the present exemplary embodiment. Explanation now follows regarding functional configuration of the banknote processing device 10 according to the present exemplary embodiment.

### 2-2. Functional Configuration

FIG. 4 is a block diagram illustrating a functional configuration of the banknote processing device 10 according to the present exemplary embodiment. As illustrated in FIG. 4, the banknote processing device 10 includes the control section 11, a data storage section 12, the display section 17, and the operation section 19. Explanation follows regarding these respective elements, however since the display section 17 and the operation section 19 have already been described above with reference to FIG. 1, further explanation thereof will be omitted.

The control section 11 controls overall operation of the banknote processing device 10. Specifically, the control section 11 controls basic operations such as pay-in, pay-out, recovery, and check counting. Respective basic operations will be explained in detail in “2-3. Basic Operation”. The control section 11 moreover controls the overall banknote processing device 10 so as to perform basic operations as instructed by a member of staff using the operation section 19 or basic operations as instructed by a member of staff using the reception terminal 30.

The control section 11 according to the present exemplary embodiment also controls the conveyance section 5, thereby controlling banknote conveyance during basic operations such as pay-in, pay-out, recovery and check counting. The control section 11 may also control banknote conveyance according to classification results of the banknote identification section 4.

The data storage section 12 holds, for example, classification results of the banknote identification section 4, and a balance of the banknote processing device 10 calculated from paid in amounts and paid out amounts.

Explanation of the functional configuration of the banknote processing device 10 according to the present exemplary embodiment has been given above. Note that the functions of the control section 11 and the data storage section 12 described above may be implemented by a hardware configuration including, for example, a Central Processing Unit (CPU), Read Only Memory (ROM), and Random Access Memory (RAM). The CPU includes computing functions and control functions, and controls overall operation of the banknote processing device 10 with various programs. The ROM is stored with, for example, programs and computation parameters employed by the CPU. The RAM is temporarily stored with, for example, a program used for execution by the CPU, and parameters that vary as appropriate during execution by the CPU.

### 2-3. Basic Operation

Pay-In Transaction

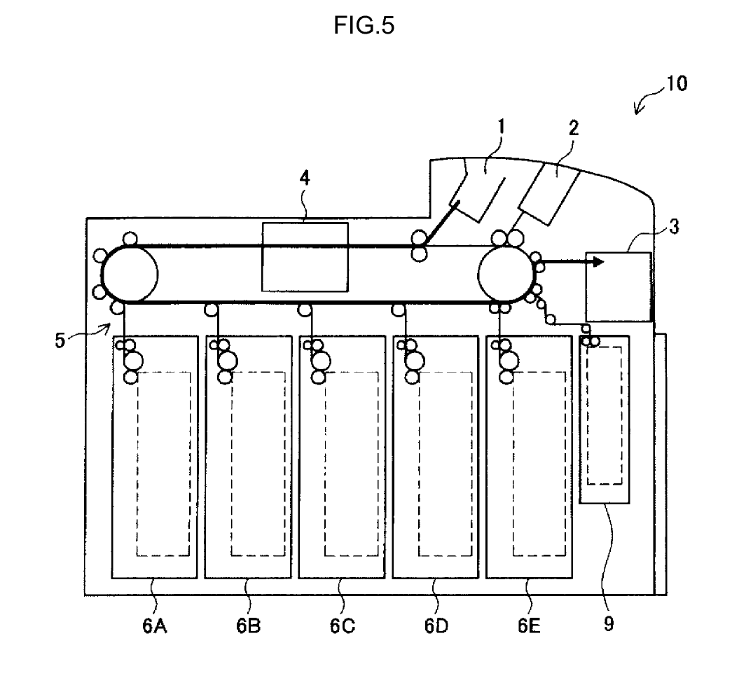

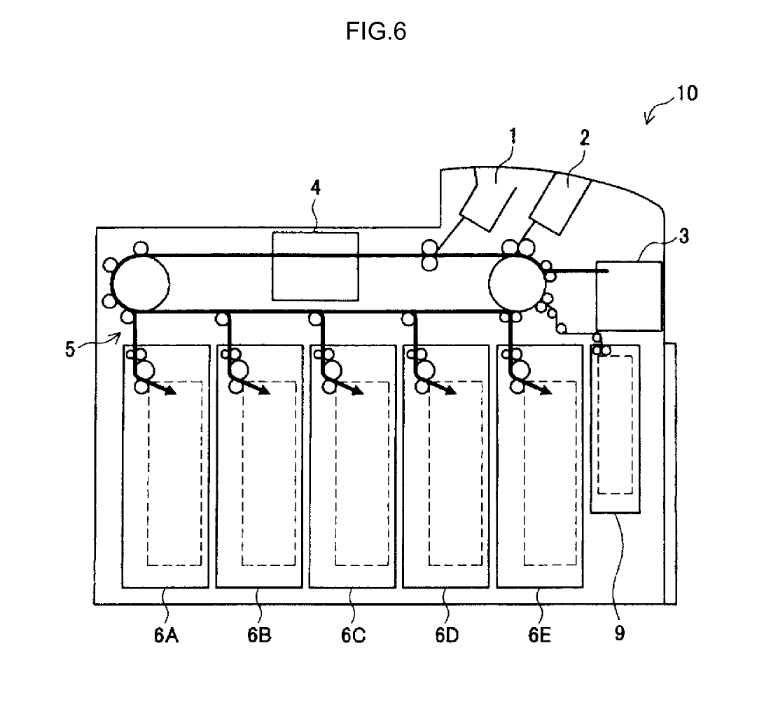

Explanation follows regarding a pay-in transaction, with reference to FIG. 5 and FIG. 6. FIG. 5 is a drawing illustrating a conveyance route of banknotes given a classification result of normal by the banknote identification section 4 during a pay-in transaction. FIG. 6 is a drawing illustrating conveyance routes in stacking processing during a pay-in transaction, in which normal banknotes stacked in the temporary holding section 3 are stacked in the respective banknote cassettes 6A to 6E according to denomination.

In a pay-in transaction, banknotes from the pay-in port 1 are first separated into individual notes, and the separated banknotes are conveyed to the banknote identification section 4. Banknotes given a classification result of normal by the banknote identification section 4 follow the route illustrated by the arrow in FIG. 5 from the banknote identification section 4, and are stacked in the temporary holding section 3. However, banknotes given a classification result of abnormal by the banknote identification section 4 (a reject banknote) are stacked in the pay-out port 2. The member of staff may reinsert any banknotes stacked in the pay-out port 2 into the pay-in port 1 for reclassification. Then, once the pay-in amount has been approved, processing transitions to stacking processing.

As illustrated in FIG. 6, in stacking processing banknotes in the temporary holding section 3 are first separated into individual notes and the separated notes are conveyed to the banknote identification section 4. Then, banknotes given a classification result of normal by the banknote identification section 4 are stacked in the banknote cassette 6A to 6E of the corresponding denomination, as illustrated in FIG. 6. However, any banknotes (reject banknotes) given a classification result of abnormal by the banknote identification section 4, such as dirty or folded 10,000 yen notes or 1000 yen notes, 2000 yen notes, 5000 yen notes, or banknotes traveling abnormally such as skewed banknotes, are stacked in the storage-only cassette 9.

Return processing is performed when pay-in banknote return (cancellation) is instructed prior to approval of a pay-in amount. In return processing, banknotes from the temporary holding section 3 are first separated into individual notes, and the separated banknotes are conveyed to the banknote identification section 4. All of the banknotes are then stacked in the pay-out port 2 regardless of whether the banknote identification section 4 gives a classification result of normal or abnormal.

Replenishment Operation

Replenishment operation is a basic operation for replenishing banknotes in the banknote processing device 10. In the banknote processing device 10 according to the present exemplary embodiment, specific possible replenishment methods include insertion port replenishment, cassette exchange replenishment, and counted cassette replenishment. Explanation follows regarding each of the replenishment methods in the above sequence.

Insertion Port Replenishment

Insertion port replenishment has operation similar to the pay-in transaction and the stacking processing described above. For example, banknotes stacked in the pay-in port 1 (insertion port) are separated into individual notes, and the separated notes are conveyed to the banknote identification section 4. Banknotes given a classification result of normal by the banknote identification section 4 are held back in the temporary holding section 3 before being stacked in the banknote cassette 6A to 6E of the corresponding denomination. However, banknotes given a classification result of abnormal by the banknote identification section 4 are stacked in the pay-out port 2.

Cassette Exchange Replenishment

Cassette exchange replenishment makes use of the detachability of the banknote cassettes 6A to 6E. Banknotes are replenished by exchanging any of the banknote cassettes 6A to 6E for a banknote cassette that has been preloaded with banknotes. Note that in cassette exchange replenishment, an operator must manually record the denomination and number of replenished banknotes.

Counted Cassette Replenishment

In counted cassette replenishment, the banknote cassette 6E is preloaded with banknotes and set in the banknote processing device 10. Banknotes are fed out from the banknote cassette 6E, one note at a time, and the fed out banknotes are conveyed to the banknote identification section 4. Banknotes given a classification result of normal by the banknote identification section 4 are stacked in the banknote cassette 6A to 6D of the corresponding denomination. However, banknotes given a classification result of abnormal by the banknote identification section 4 are stacked in the storage-only cassette 9. Since counting processing is executed by the banknote identification section 4 in counted cassette replenishment, there is no need for the denomination and number of replenished banknotes to be manually recorded by an operator.

Recovery Operation

Recovery operation is a basic operation to recover banknotes from the banknote processing device 10. In the banknote processing device 10 according to the present exemplary embodiment, specific possible recovery methods are pay-out port recovery, exchange cassette recovery, and counted cassette recovery. Pay-out port recovery will be explained in detail in “3-3. Third Exemplary Embodiment”. Explanation follows regarding exchange cassette recovery and counted cassette recovery in that sequence.

Exchange Cassette Recovery

Exchange cassette recovery makes use of the detachability of the banknote cassettes 6A to 6E. A recovery task is performed by removing from the banknote processing device 10 a specific banknote cassette 6 in which banknotes have been stacked. Note that in exchange cassette recovery, an operator has to take the banknotes out from the removed banknote cassette 6 and manually count the denomination and number of the recovered banknotes.

Counted Cassette Recovery

In counted cassette recovery, banknotes are firstly fed out, one note at a time from a recovery target banknote cassette out of the banknote cassettes 6A to 6D, and the fed out banknotes are conveyed to the banknote identification section 4. Banknotes given a classification result of normal by the banknote identification section 4 are stacked in the banknote cassette 6E. However, banknotes given a classification result of abnormal by the banknote identification section 4 are stacked in the storage-only cassette 9.

After this processing has been performed for all of the banknotes stacked in the recovery target banknote cassette, an operator recovers the banknotes by removing the banknote cassette 6E and the storage-only cassette 9 from the banknote processing device 10. Since counting processing is executed by the banknote identification section 4 in counted cassette recovery, there is no need for the operator to manually count the denomination and number of recovered banknotes.

Explanation has been given above regarding basic operation of the banknote processing device 10. Note that detailed explanation of a pay-out transaction will be given in “3. Respective Exemplary Embodiments”.

### 2-4. Direct Pay-In

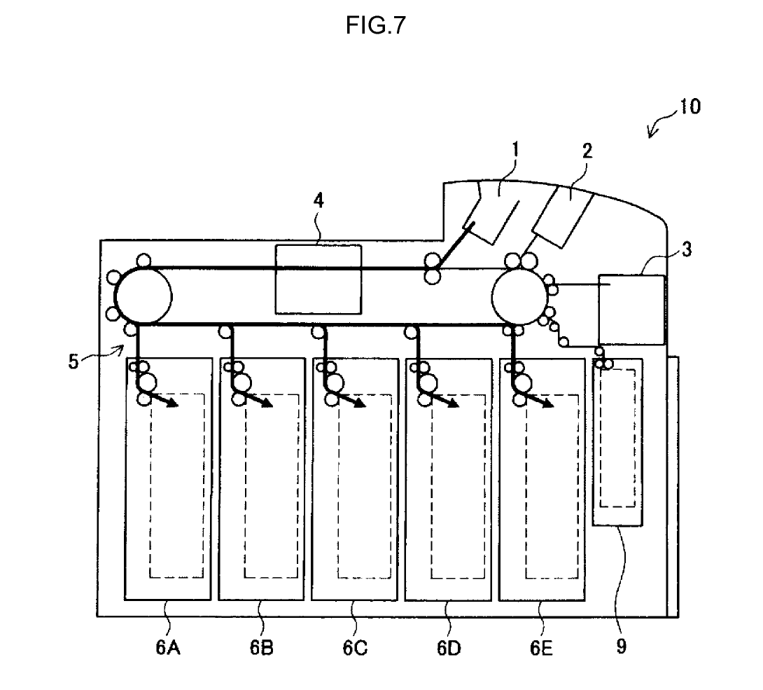

Note that as pay-in transaction operation, direct pay-in processing, in which pay-in banknotes are stacked directly in the banknote cassettes 6A to 6E without being held back in the temporary holding section 3 is possible, in addition to the normal pay-in processing described above in which the pay-in banknotes are held back in the temporary holding section 3 before being stacked in the banknote cassettes 6A to 6E from the temporary holding section 3. Explanation follows regarding direct pay-in processing, with reference to FIG. 7. FIG. 7 is a drawing illustrating conveyance routes in direct pay-in processing for banknotes fed out, one note at a time, from the pay-in port 1 until the banknotes are stacked in the respective banknote cassettes 6A to 6E.

In direct pay-in processing, banknotes from the pay-in port 1 are firstly separated into individual notes, and the separated banknotes are conveyed to the banknote identification section 4. Banknotes given a classification result of normal by the banknote identification section 4 follow the route from the banknote identification section 4 illustrated by the arrows in FIG. 7 and are stacked in the banknote cassette 6A to 6E of the corresponding denomination. However, banknotes (reject banknotes) given a classification result of abnormal by the banknote identification section 4 are stacked in the pay-out port 2. The member of staff may reinsert any banknotes stacked in the pay-out port 2 into the pay-in port 1 for reclassification.

In comparison to the normal pay-in processing described above, direct pay-in processing enables a reduction in pay-in processing time since banknotes are stacked directly in the banknote cassettes without being held back in the temporary holding section 3. Moreover, direct pay-in processing enables a reduction in travel, and therefore a reduction in the occurrence of jams, since there is no need to hold back the banknotes in the temporary holding section 3. Direct pay-in processing accordingly enables pay-in transactions, for example, when the temporary holding section 3 is out of order, as well as in structures that do not include the temporary holding section 3.

In the banknote processing device 10 according to the present exemplary embodiment, a setting may be made to select between the normal pay-in processing described above and direct pay-in processing.

### 3. Respective Exemplary Embodiments

Next, explanation follows regarding securing the reject route according to the present exemplary embodiment, with examples of plural exemplary embodiments. The present exemplary embodiment secures a reject route during pay-out or pay-out port recovery from the banknote cassettes 6A to 6E, thereby enabling an increase in the number of banknote cassettes that can be employed in a pay-out transaction or a pay-out port recovery operation compared to the with structure of the banknote processing device 100 illustrated in FIG. 2.

### 3-1. First Exemplary Embodiment

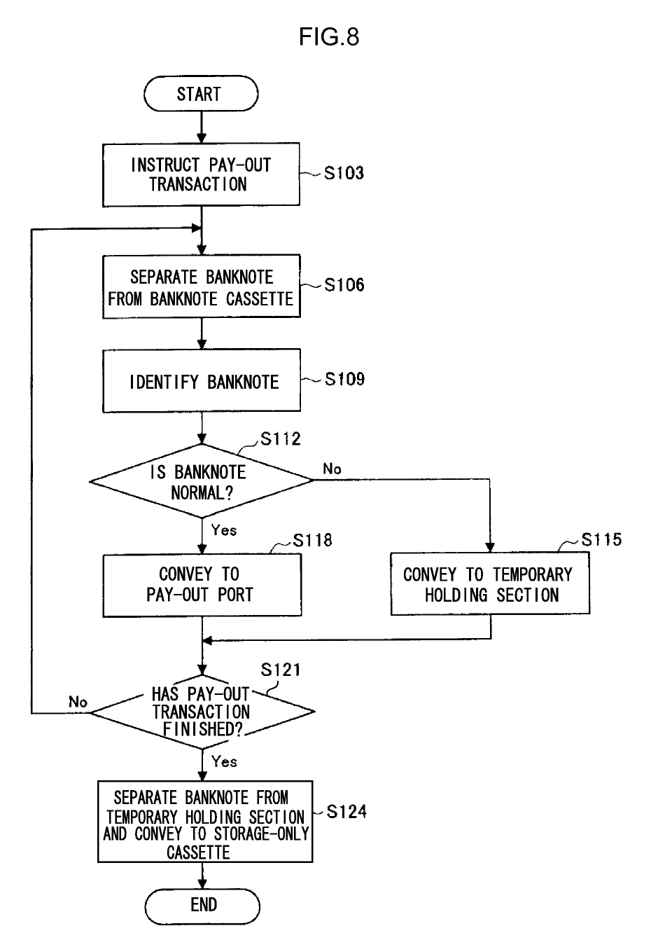

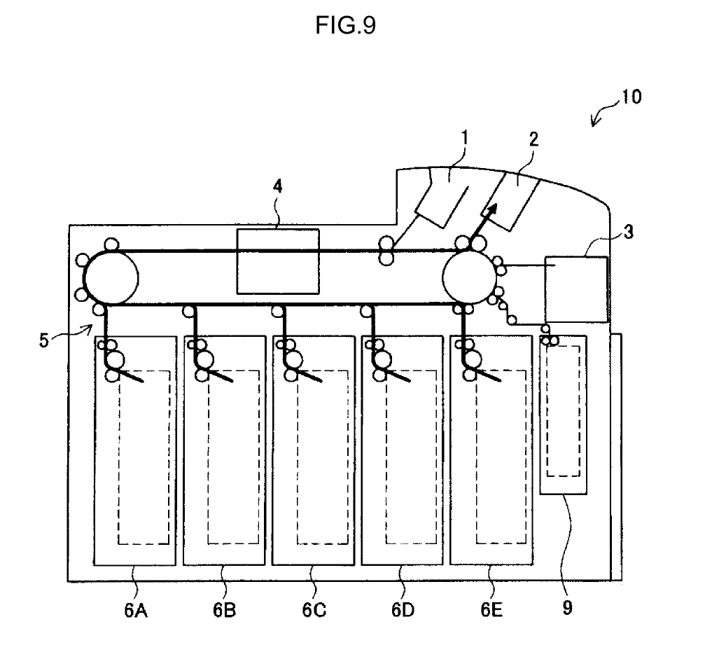

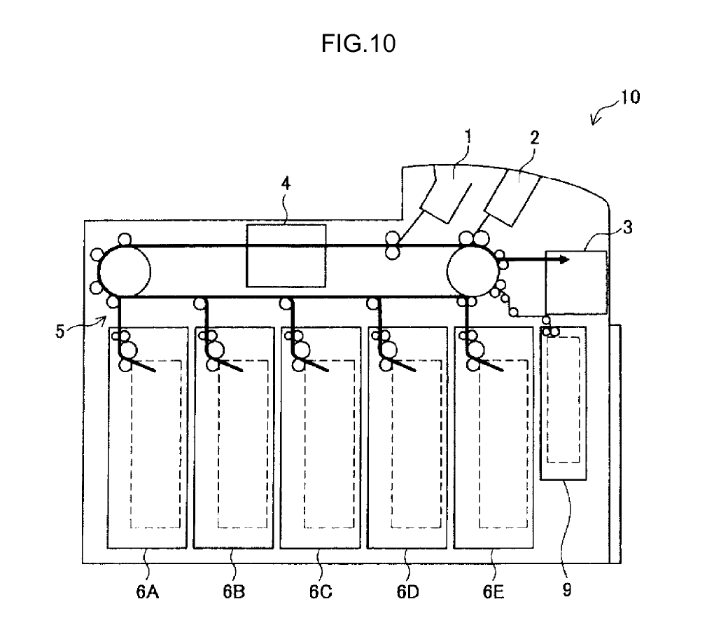

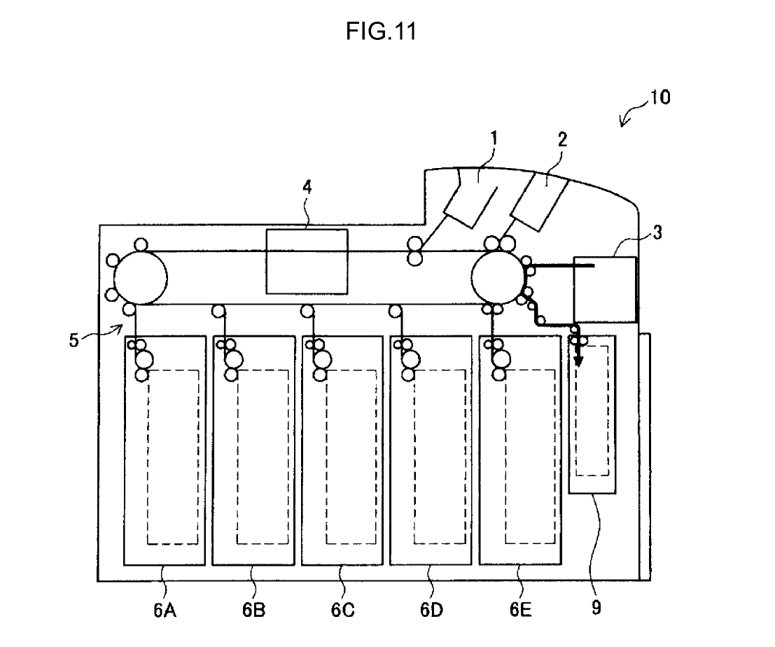

In a first exemplary embodiment, explanation follows regarding securing the reject route during a pay-out transaction, with reference to FIG. 8 to FIG. 11. FIG. 8 is a flow chart illustrating banknote conveyance control in a pay-out transaction according to the first exemplary embodiment. FIG. 9 is a drawing illustrating conveyance routes of a normal banknote under banknote conveyance control during a pay-out transaction according to the first exemplary embodiment. FIG. 10 and FIG. 11 are drawings illustrating conveyance routes of a reject banknote under banknote conveyance control during a pay-out transaction according to the first exemplary embodiment.

As illustrated in FIG. 8, firstly, when at step S103 a member of staff instructs a pay-out transaction, then at step S106 the control section 11 controls conveyance such that banknotes from specific banknote cassettes 6 are separated into individual notes, and the separated banknotes are conveyed to the banknote identification section 4 according to the denomination and number of banknotes to be paid out.

Next, at step S109, the banknote identification section 4 identifies the denomination and state of the respective conveyed banknotes. Then, at step S112, the banknote identification section 4 classifies the conveyed banknotes by whether or not they are normal.

When the banknote identification section 4 classifies a banknote as normal, at step S118 the control section 11 stacks the banknote in the pay-out port 2. The conveyance route of such a normal banknote in a pay-out transaction is illustrated by the arrow in FIG. 9. As illustrated by the arrow in FIG. 9, banknotes fed out from the banknote cassettes 6A to 6E corresponding to the pay-out amount are conveyed to the banknote identification section 4, and are stacked in the pay-out port 2 when classified as normal by the banknote identification section 4.

However, when the banknote identification section 4 classifies a banknote as abnormal, at step S115 the control section 11 stacks the reject banknote in the temporary holding section 3. The conveyance route (reject route) of such a reject banknote in a pay-out transaction is illustrated by the arrow in FIG. 10. As illustrated by the arrow in FIG. 10, banknotes corresponding to the pay-out amount fed out from the banknote cassettes 6A to 6E are conveyed to the banknote identification section 4, and are stacked in the temporary holding section 3 when classified as abnormal (reject determination) by the banknote identification section 4.

Next, at step S121, when the full number of banknotes of each denomination to be paid out has been stacked in the pay-out port 2 (pay-out transaction completion), at step S124 the control section 11 controls conveyance such that the reject banknotes that have been held back in the temporary holding section 3 are separated from the temporary holding section 3 and stacked in the storage-only cassette 9. The conveyance route (reject route) of such a reject banknote to the storage-only cassette 9 in a pay-out transaction is illustrated by the arrow in FIG. 11. The reject banknotes stacked in the temporary holding section 3 are separated from the temporary holding section 3, one note at a time, and stacked in the storage-only cassette 9 as illustrated by the arrow in FIG. 11.

As described above, in the first exemplary embodiment conveyance is controlled in a pay-out transaction such that reject banknotes are held back in the temporary holding section 3, and the reject banknotes held back in the temporary holding section 3 are stacked in the storage-only cassette 9 after the pay-out transaction has been completed. The reject route can accordingly be secured. Accordingly, each of the banknote cassettes 6A to 6E can be employed in pay-out transactions in the banknote processing device 10 according to the present exemplary embodiment. One extra denomination can accordingly be handled since the number of banknote cassettes that can be employed in pay-out transactions is greater than in the banknote processing device 100 illustrated in FIG. 2.

### 3-2. Second Exemplary Embodiment

In the first exemplary embodiment described above, after a pay-out transaction has been completed, processing is required to convey reject banknotes from the temporary holding section 3 to the storage-only cassette 9 (step S124 in FIG. 8). However, in the second exemplary embodiment, conveyance is controlled such that reject banknotes are not held back in the temporary holding section 3, and are stacked directly in the storage-only cassette 9.

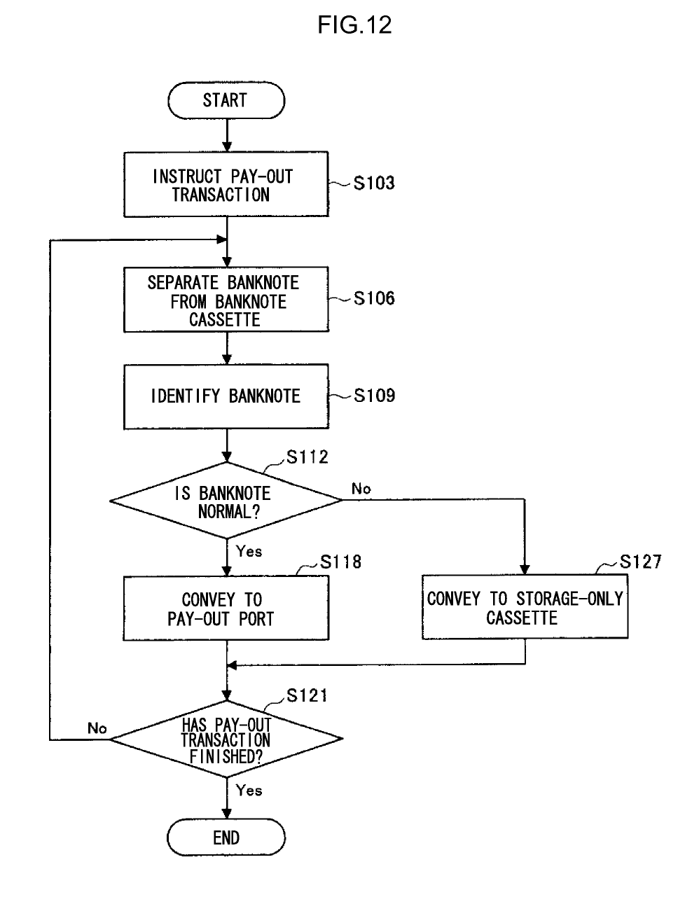

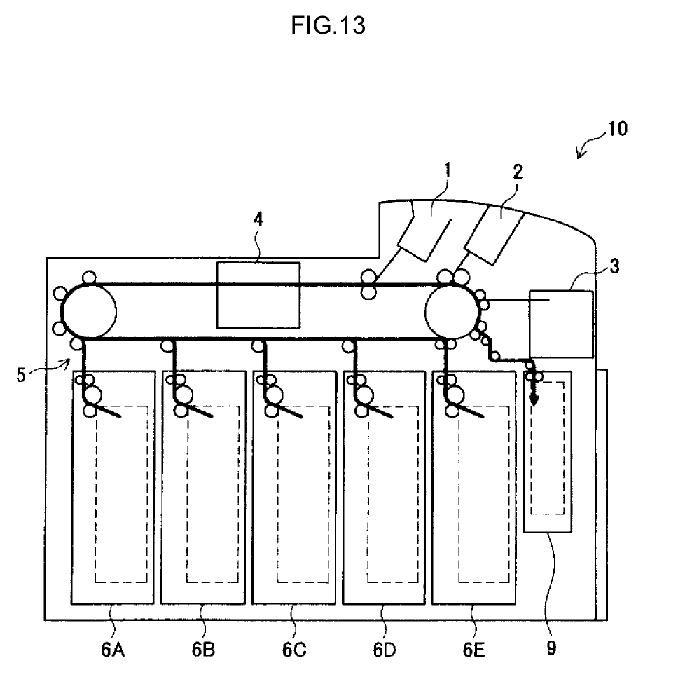

Explanation follows regarding the second exemplary embodiment with reference to FIG. 12 and FIG. 13. FIG. 12 is a flow chart illustrating banknote conveyance control during a pay-out transaction according to the second exemplary embodiment. FIG. 13 is a drawing illustrating conveyance routes (reject route) of a reject banknote under banknote conveyance control in a pay-out transaction according to the second exemplary embodiment.

Processing at steps S103 to S112, S118, and S121 illustrated in FIG. 12, is similar to that of the equivalent steps explained with reference to FIG. 8.

When at step S112 illustrated in FIG. 12 the banknote identification section 4 classifies a banknote as abnormal, at step S127 the control section 11 stacks the reject banknote in the storage-only cassette 9. The conveyance route (reject route) of such a reject banknote in a pay-out transaction is illustrated by the arrow in FIG. 13. As illustrated by the arrow in FIG. 13, banknotes corresponding to the pay-out amount fed out from the banknote cassettes 6A to 6E are conveyed to the banknote identification section 4, and are stacked in the storage-only cassette 9 when classified as abnormal (reject determination) by the banknote identification section 4.

As has been described above with reference to FIG. 3, the banknote cassettes 6A to 6E of the present exemplary embodiment are provided only on the second route M on the opposite side of the banknote identification section 4 to the first route L on the first pay-out port 2 side, between the banknote identification section 4 and the storage-only cassette 9. As illustrated in FIG. 13, in the present exemplary embodiment a route (reject route) can accordingly be secured for banknotes that are fed out from the banknote cassettes 6A to 6E and conveyed to the banknote identification section 4, classified as abnormal by the banknote identification section 4, and conveyed to the storage-only cassette 9. In the present exemplary embodiment a banknote fed out from the banknote cassettes 6A to 6E can accordingly be conveyed to the storage-only cassette 9 without stopping.

Moreover, in the banknote processing device 10 according to the present exemplary embodiment, each of the banknote cassettes 6A to 6E can be employed in pay-out transactions. One extra denomination can accordingly be accommodated in, for example, pay-out transactions since the number of banknote cassettes that can be employed in pay-out transactions is greater than in the banknote processing device 100 illustrated in FIG. 2.

### 3-3. Third Exemplary Embodiment

In the first and second exemplary embodiments described above, explanation has been given regarding securing the reject route in a pay-out transaction, however the present invention is not limited thereto, and, for example, the reject route may also be secured in a pay-out port recovery operation. Pay-out port recovery is an example of the recovery operation described above.

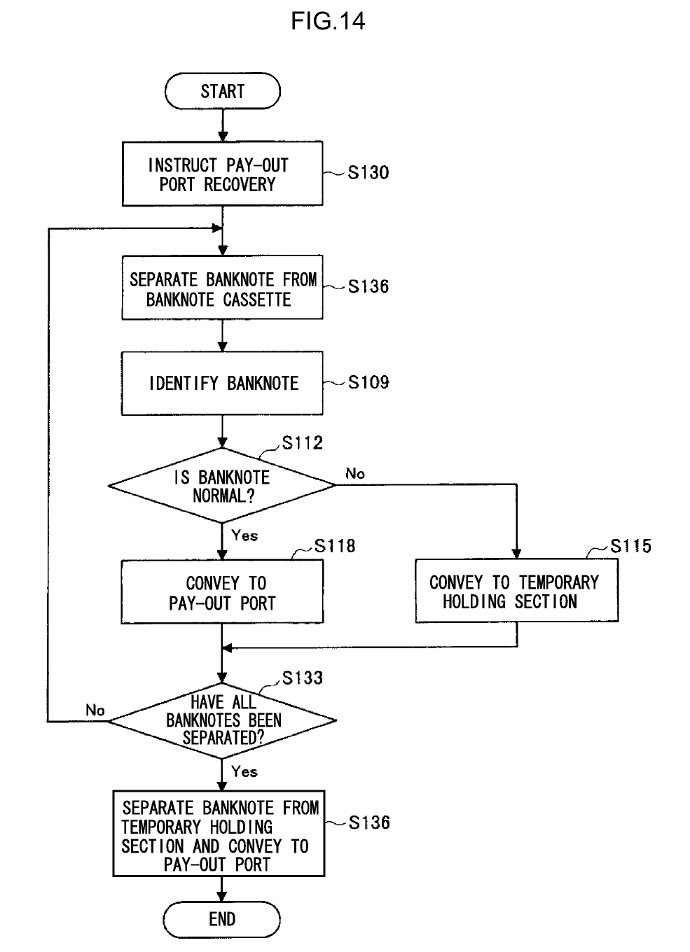

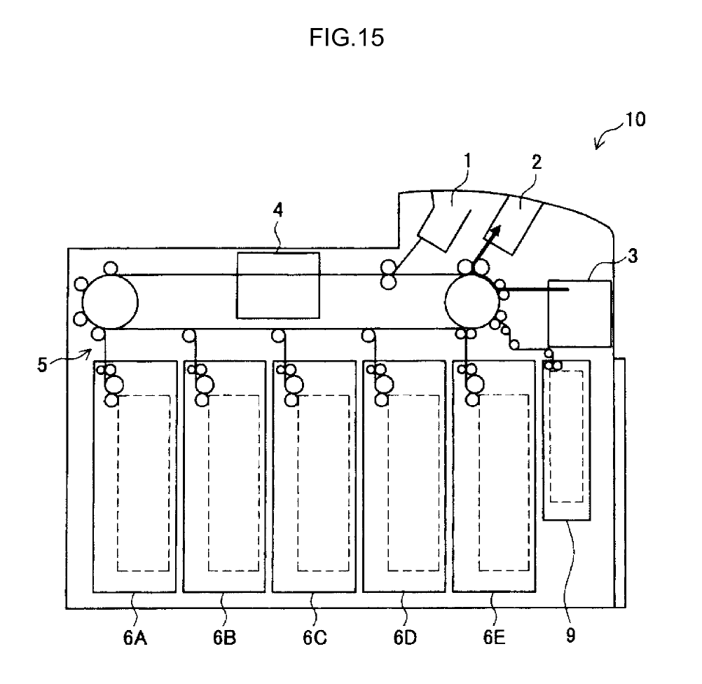

Explanation follows regarding a third exemplary embodiment, with reference to FIG. 14 and FIG. 15. FIG. 14 is a flow chart illustrating banknote conveyance control during pay-out port recovery according to the third exemplary embodiment. FIG. 15 is a drawing illustrating a conveyance route (reject route) of a reject banknote under banknote conveyance control during pay-out port recovery according to the third exemplary embodiment.

As illustrated in FIG. 14, when a member of staff has instructed a pay-out port recovery operation at step S130, then at step S136, the control section 11 controls conveyance so as to separate banknotes, one note at a time, from a specific recovery target banknote cassette 6, and convey the separated banknotes to the banknote identification section 4.

At subsequent steps S109 to S118, processing is similar to that of the equivalent steps explained with reference to FIG. 8. In particular, when a banknote has been classified as abnormal by the banknote identification section 4, at step S115 the control section 11 stacks the reject banknote in the temporary holding section 3. The conveyance route (reject route) of such a reject banknote in a pay-out transaction is illustrated in FIG. 10.

Next, at step S133, when all of the banknotes that were stacked inside the specific recovery target banknote cassette 6 have been fed out, then at step S136 the control section 11 controls conveyance such that the reject banknotes held back in the temporary holding section 3 are separated from the temporary holding section 3 and stacked in the paying out port 2. The conveyance route (reject route) of such a reject banknote from the temporary holding section 3 to the pay-out port 2 in pay-out port recovery is illustrated by the arrow in FIG. 15. The reject banknotes stacked in the temporary holding section 3 are separated from the temporary holding section 3, one note at a time, and stacked in the pay-out port 2 as illustrated by the arrow in FIG. 15.

Note that the control section 11 may control such that conveyance of the reject banknotes to the pay-out port 2 described at step S136 is performed when it has been detected that all of the normal banknotes conveyed to the pay-out port 2 have been collected by a member of staff, or performed when pay-out port recovery of the reject banknotes is instructed by the member of staff.

As has been described above, in the third exemplary embodiment, in pay-out port recovery reject banknotes are held back in the temporary holding section 3, and all of the banknotes inside the recovery target banknote cassette 6 are separated. The reject route can then be secured by controlling conveyance such that the reject banknotes that have been held back in the temporary holding section 3 are stacked in the pay-out port 2. Each of the banknote cassettes 6A to 6E can thus be configured as a pay-out port recovery target in the banknote processing device 10 of the present exemplary embodiment, such that there is no need to remove the banknote cassettes 6A to 6E in a recovery operation as in the exchange cassette recovery and the counted cassette recovery described above. The task is accordingly accomplished in less time.

Moreover in the present exemplary embodiment the member of staff is able to collect the reject banknotes from the pay-out port 2 due to conveying the reject banknotes held back in the temporary holding section 3 to the pay-out port 2. There is accordingly no need to remove the storage-only cassette 9 in the recovery operation as in the exchange cassette recovery and the counted cassette recovery described above, and the task is accomplished in less time.

### 4. Conclusion

As has been described above, according to an exemplary embodiment of the present invention, it is possible to secure a reject route that does not overlap with a banknote conveyance route from the banknote cassettes 6A to 6E to the banknote identification section 4. Pay-out transactions and pay-out port recovery from the banknote cassettes 6A to 6E can thereby be performed. Moreover, one extra denomination can be handled since the number of banknote cassettes that can be employed in pay-out transactions and pay-out port recovery is greater than in the banknote processing device 100 illustrated in FIG. 2.

Specifically, according to the first exemplary embodiment, the reject route can be secured due to controlling conveyance such that reject banknotes are held back in the temporary holding section 3 during a pay-out transaction, and the banknotes that have been held back in the temporary holding section 3 are stacked in the storage-only cassette 9 after the pay-out transaction has been completed.

Moreover, according to the second exemplary embodiment, the reject route can be secured since the banknote cassettes 6A to 6E are provided only on the route on the opposite side to the reject banknote conveyance route from the banknote identification section 4 to the storage-only cassette 9.

Moreover, according to the third exemplary embodiment, the reject route can be secured due to controlling conveyance such that in pay-out port recovery, reject banknotes are held back in the temporary holding section 3, and the reject banknotes that have been held back in the temporary holding section 3 are stacked in the pay-out port 2 after feeding out of banknotes from the banknote cassette(s) 6 has been completed.

Note that detailed explanation has been given regarding preferred exemplary embodiments of the present invention with reference to the attached drawings; however the present invention is not limited to such examples. It would be clear to a practitioner skilled in the art that various modifications and alterations are possible within the range of the technical concepts recited in the scope of claims, and such modifications and alterations obviously fall within the technical scope of the present invention.

For example, a computer program may be produced to cause hardware including, for example, a CPU, ROM, and RAM installed in the banknote processing device 10 to perform an equivalent function to the control section 11 of the banknote processing device 10 described above. A storage medium may also be provided stored with such a computer program.

Moreover, in the exemplary embodiments described above, explanation has been given in which the banknote processing device 10 according to the present exemplary embodiment is applied to a staff-operated terminal, however the banknote processing device 10 of the present exemplary embodiment is not limited thereto. For example, the banknote processing device 10 may be applied to a customer operated terminal, such as a cash processing section of an automatic transaction device typified by a banknote recirculating (recycling) Automated Teller Machine (ATM). Automatic transaction devices are installed at numerous locations such as in banks, at railway stations and in convenience stores. A customer may perform transactions such as pay-in transactions, pay-out transactions, and balance enquiries by performing various operations on a display screen displayed on the automatic transaction device.

### EXPLANATION OF THE REFERENCE NUMERALS

1 pay-in port
2 pay-out port
3 temporary holding section
4 banknote identification section
5 conveyance section
6, 6A to 6E banknote cassette
7 banknote cassette with reject box
28 banknote storage box
29 reject box
9 storage-only cassette
10 banknote processing device
11 control section
12 data storage section
17 display section
19 operation section
30, 30a, 30b reception terminal
32 dedicated network
35 financial institution host
L first route L
M second route M

1. A banknote processing device comprising:
a dispensing port that dispenses banknotes;
a banknote identification section that identifies whether or not banknotes are normal; and
a storage-only storage section that stores banknotes that the banknote identification section has identified as abnormal, wherein
out of a first route on a dispensing port side between the banknote identification section and the storage-only storage section and a second route on an opposite side from the first route, one, or two or more, banknote storage sections capable of storing and feeding out banknotes are provided only on the second route side.

2. The banknote processing device of claim 1, further comprising:
a control section that, in a pay-out transaction, controls conveyance such that banknotes fed out from the banknote storage section are conveyed to the banknote identification section via the second route.

3. The banknote processing device of claim 2, wherein:
the control section controls conveyance such that any of the banknotes rejected by the banknote identification section are conveyed to the storage-only storage section via the first route.

4. The banknote processing device of claim 2, further comprising:
a temporary holding section that is provided on the first route, and that temporarily stores the banknotes, wherein
the control section controls conveyance such that any of the banknotes rejected by the banknote identification section are conveyed to the temporary holding section via the first route, and after the pay-out transaction has been completed, the banknotes stored in the temporary holding section are conveyed to the storage-only storage section via the first route.

5. The banknote processing device of claim 1, further comprising:
a control section that controls conveyance during dispensing port recovery such that banknotes fed out from the banknote storage section are conveyed to the banknote identification section via the second route.

6. The banknote processing device of claim 5, further comprising:
a temporary holding section that is provided on the first route, and that temporarily stores the banknotes, wherein
the control section controls conveyance such that any banknotes rejected by the banknote identification section are conveyed to the temporary holding section via the first route, and after every banknote has been fed out from the banknote storage section, the banknotes stored in the temporary holding section are conveyed to the dispensing port.

7. The banknote processing device of claim 2, wherein:
the control section controls conveyance such that banknotes identified by the banknote identification section as normal are conveyed to the dispensing port.

8. The banknote processing device of claim 3, wherein:
the control section controls conveyance such that banknotes identified by the banknote identification section as normal are conveyed to the dispensing port.

9. The banknote processing device of claim 4, wherein:
the control section controls conveyance such that banknotes identified by the banknote identification section as normal are conveyed to the dispensing port.

10. The banknote processing device of claim 5, wherein:
the control section controls conveyance such that banknotes identified by the banknote identification section as normal are conveyed to the dispensing port.

11. The banknote processing device of claim 6, wherein:
the control section controls conveyance such that banknotes identified by the banknote identification section as normal are conveyed to the dispensing port.
